(19) United States
(12) Patent Application Publication
(10) Pub. No.: US 2015/0225302 A1
(43) Pub. Date: Aug. 13, 2015

(54) IMPROVED POROUS BODIES COMPRISED OF MULLITE AND METHODS OF FORMING THEM

(71) Applicant: DOW GLOBAL TECHNOLOGIES LLC, Midland, MI (US)

(72) Inventors: Jun Cai, Midland, MI (US); Michael T. Malanga, Midland, MI (US); Paul C. Vosejpka, Midland, MI (US)

(21) Appl. No.: 14/426,608

(22) PCT Filed: Mar. 4, 2013
(86) PCT No.: PCT/US2013/028838

§ 371 Date: Mar. 6, 2015

Related U.S. Application Data
(60) Provisional application No. 61/710,928, filed on Oct. 8, 2012.

(51) Int. Cl. C04B 38/00; C04B 35/185; B01D 39/20

(52) U.S. Cl. CPC C04B 38/009; B01D 39/2075; C04B 38/0087; C04B 35/185

(57) ABSTRACT

A porous ceramic body useful for making particulate filters is comprised of acicular mullite grains bound together by a ceramic grain boundary phase, wherein said porous acicular mullite body has a bulk carbon content from 0.005% to 10% by weight of the body. The porous body may be made by forming a mixture of mullite precursors (e.g., alumina and silica) and a compound that is inorganic carbon (graphitic or amorphous), inorganic compound that contains carbon (e.g., metal carbide) or an organic compound that decomposes to form inorganic carbon or an inorganic compound that contains carbon and heating in an atmosphere containing fluorine to form the acicular mullite body and removing the fluorine.

### FIELD OF THE INVENTION

The invention relates to bodies comprised of mullite and method of forming these bodies. In particular, the invention relates to bodies having fused interlocked acicular grains and a method of forming them.

### BACKGROUND OF THE INVENTION

Recently, more stringent regulations of particulate matter emitted by diesel engines and gasoline engines such as gasoline direct injection engines have been passed or are contemplated in Europe and the United States. To meet these regulations, particulate filters generally have been necessary and are anticipated will be necessary.

These particulate filters must meet multiple contradictory exacting requirements. For example, the filter must have sufficient porosity (generally greater than 55 percent porosity) while still retaining most of the emitted micrometer sized diesel particulates (generally greater than 90 percent capture of the emitted particulates). The filter must also be permeable enough so that excessive back pressure does not occur too quickly, while still being able to be loaded with a great amount of soot before being regenerated. The filter must withstand the corrosive exhaust environment for long periods of time. The filter must have an initial strength to be placed into a container attached to the exhaust system. The filter must be able to withstand thermal cycling (i.e., retain adequate strength) from the burning off of the soot entrapped in the filter (regeneration) over thousands of cycles where local temperatures may reach as high as 1600° C. From these stringent criteria, ceramic filters have been the choice of material to develop a diesel particulate filter.

Ceramic filters of sintered cordierite have been explored as a possible diesel particulate filter. Cordierite was explored because of its low cost and use as a three-way catalyst support in automotive exhaust systems. Cordierite filters have been utilized in large truck applications, but have suffered from high backpressures, short life before needing to be cleaned of ash build up and thermal degradation due to localized hot spots.

More recently, silicon carbide has been utilized in light duty diesel engines, mostly because of its ability to withstand more soot than cordierite and it's more thermally stable. Silicon carbide, however, suffers, for example, from having to be sintered at high temperature using expensive fine silicon carbide powder. Because silicon carbide is sintered, the pore structure that develops results in limited soot loading before excessive back pressure develops just as for cordierite.

In addition, mullite of interlaced crystals grown together have been described by U.S. Pat. No. 5,098,455, for use as a diesel particulate trap. These filters have advantages of low pressure drop and thermal stability, but could have further improved properties (e.g., improved thermal shock behavior) to be more widely utilized.

Accordingly, it would be desirable to provide an improved ceramic particulate filter that has improved thermal shock behavior or solves one or more of the problems of the prior art, such as one of those described above.

### SUMMARY OF THE INVENTION

A first aspect of the present invention is a method of making a body comprised of mullite comprising,
(a) mixing one or more precursor compounds having the elements present in mullite and a carbon containing material that is: (i) an organic compound containing carbon that decomposes to form graphitic, amorphous carbon or inorganic compound containing carbon upon heating of step (b); (ii) graphitic carbon; (iii) amorphous carbon; (iv) inorganic compound containing carbon or (v) combination thereof to form a mixture,
(b) heating the mixture of step (b) under an atmosphere having a fluorine containing gas to form a porous body comprised of mullite and having fluorine in an amount greater than 1% by weight, and
(c) removing the fluorine to form the porous body comprised of mullite, wherein the amount of fluorine is less than 1% by weight of the body.

A second aspect of the invention is a porous body comprised of acicular mullite grains bound together by a ceramic grain boundary phase, wherein the bulk carbon content is generally from 0.005% to 10% by weight of the body and the amount of fluorine is less than 1% by weight of the body. The amount of carbon may be at least about 0.001%, 0.0015%, to at most 5% or 1%. The amount of fluorine is typically less than 0.8%, 0.6%, 0.5%, 0.3%, 0.1% or even no fluorine.

Surprisingly, the presence of carbon in the porous body improves thermal shock factor compared to the same composition made in the absence of this carbon. In addition, the body comprised of mullite may also display improved corrosion resistance to an exhaust environment (i.e., improve the retention of its thermal shock resistance over time).

The body of the present invention may be used in any application suitable for porous refractory ceramics. Examples include filters, refractories, thermal and electrical insulators, reinforcement for composite bodies of metals or plastics, catalysts and catalyst supports. In particular, they are suited for particulate filters such as internal combustion exhaust filters.

### BRIEF DESCRIPTION OF THE DRAWINGS

FIG. 1 is an energy dispersive X-ray spectroscopy micrograph of a polished section of a porous body of this invention showing a crystalline silicate phase within the ceramic grain boundary phase.

FIG. 2 is an energy dispersive X-ray spectroscopy micrograph of a polished section of a porous body of this invention having SiC dispersed within the ceramic grain boundary phase.

### DETAILED DESCRIPTION OF THE INVENTION

### Body Comprised of Mullite

The body comprised of mullite is comprised of mullite grains that are bound together by a ceramic grain boundary. It is desirable that the mullite grains comprise at least about 25 percent of the body by volume. Preferably the mullite grains comprise at least about 40 percent, more preferably at least about 50 percent, even more preferably at least about 99 percent by volume of the composition. The body, in addition to the mullite grains may contain other ceramic grains such as cordierite and a ceramic grain boundary phase comprised of an alumino-silicate glass. Examples of compositions containing mullite and cordierite useful in this invention include those described in PCT Pat. Publ. No. WO/2010/033763 and PCT Appl. No. PCT/US12/031053. The alumino-silicate glass may contain metals other than Si and Al in the form of oxides, which may be amorphous or crystalline precipitates within the alumino-silicate glass. Such metals may arise from impurities arising in the precursor materials used to make the mullite (e.g., clay), introduced in making the mullite (e.g., wear from mixing equipment) or introduced to achieve certain morphologies or glass compositions as described in U.S. Pat. No. 7,485,594. Such metals may also arise, for example, from metals introduced by use of a metal carbide to make the composition.

Typically, the amount of such other metals does not exceed about 5% by weight of the mullite ceramic body. Desirably, the metals are at most 2%, 1.5%, 1%, 0.5%, 0.25%, 0.1% to as low a practicable amount (e.g., 10 ppm by weight).

The ceramic grain boundary phase, generally, is situated at the grain surface and at intersecting grain surfaces.

The mullite grains generally are grains that have an aspect ratio of greater than about 2 (e.g., length twice as great as width), which are referred to as “acicular” herein. Desirably, the acicular grains present in the body have an average aspect ratio of at least about 3. Preferably, the average aspect ratio is at least about 4, more preferably at least about 5, even more preferably at least about 8 and most preferably at least about 10 to at most about 100 or 50.

The microstructure may be determined by suitable techniques such as microscopy on a polished section. For example, the average mullite grain size may be determined from a scanning electron micrograph (SEM) of a polished section of the body, wherein the average grain size may be determined by the intercept method described by Underwood in Quantitative Stereology, Addison Wesley, Reading, Mass., (1970).

Even though the theoretical Al/Si mullite stoichiometry is 3 (3Al₂O₃.2SiO₂), the bulk Al/Si stoichiometry of the mullite within the body may be any suitable stoichiometry, such as 4.5 Al/Si to 2 Al/Si. The most suitable stoichiometry is dependent on factors such as the precursors and processing used. Bulk stoichiometry means the ratio of Al to Si in the body of the mullite grains (i.e., not each individual grain). It is preferred that the bulk stoichiometry of the mullite in the body may be at least 3, 3.2, 3.5, or 3.8 to at most 4.4 or 4.2. The bulk stoichiometry may be measured by any suitable techniques, such as those known in the art, including, for example, X-ray fluorescence.

It is not understood, but, as further detailed below, the addition of carbon during the formation of the porous body has been discovered to surprisingly improve the thermal shock resistance, strength and may improve the corrosion resistance of the acicular mullite body. It is believed, but not limiting in any way, that the addition of such carbon is beneficial in forming a grain boundary phase between the ceramic grains having improved properties.

Typically, the porous body comprised of mullite will have some bulk carbon merely from adsorbed compounds found in the environment and trace amounts introduced in processing of the material. This amount is typically less than 0.005% by weight of the porous body. In contrast, the body of this invention typically has a bulk carbon from 0.005% to 10 percent by weight. The amount of bulk carbon in the may be at least about 0.01%, or 0.015% to at most 1 percent. It is understood that the bulk carbon of the porous body precludes carbon from a cement that may be used to adhere separate monolithic porous bodies of this invention to form a larger porous structure (e.g., honeycomb comprised of smaller monolithic porous honeycombs of this invention that have been adhered together using a cement).

The bulk carbon content may be determined by known techniques such as combustion infrared detection techniques using equipment such as CS844 Series Carbon/Sulfur Analyzer available from LECO Corporation, St. Joseph, Mich.

The carbon may be, for example, in the form of an oxy-carbide crystalline or amorphous species within the glass, or metal carbides dispersed within the ceramic grain boundary phase. Desirably, only a portion of the carbon is present as a metal carbide inclusion (particulate) within the ceramic grain boundary phase. The portion of the carbon that is present as a metal carbide may be at most 50%, 60%, 70%, 80%, 90%, 95% and even none detectable using typical analytical techniques such as X-ray diffraction or energy dispersive X-ray spectrometry.

In a particular embodiment the porous body is comprised of a metal carbide that is dispersed within the ceramic grain boundary phase. Exemplary metal carbides include boron carbide, silicon carbide, tungsten carbide, hafnium carbide, zirconium carbide, aluminum boron carbides, aluminum carbide, titanium carbide, and vanadium carbide. It is also understood that the carbide may be in the form of an oxy-carbide, nitro-carbide or oxy-nitro-carbide of the same metals. In a preferred embodiment, the metal carbide is a carbide having a mullite precursor element (e.g., Si or Al). Preferably, the metal carbide is silicon carbide.

The porous body of the invention may also have a crystalline silica phase present in the ceramic grain boundary phase. In a particular embodiment the ceramic grain boundary phase may be comprised of a phase separated alumino silicate glass and crystalline silica phase.

Generally, the body has a porosity of at least about 40 percent to at most about 85 percent. Preferably, the body has a porosity of at least about 45 percent, more preferably at least about 50 percent, even more preferably at least about 55 percent, and most preferably at least about 57 percent to preferably at most about 80 percent, more preferably at most about 75 percent, and most preferably at most about 70 percent.

Surprisingly, the body containing the aforementioned carbon has improved thermal shock factor (TSF) compared to a mullite body failing to have said carbon while having essentially the same porosity. For example, the TSF of the mullite body of this invention may have a TSF that is 110%, 120%, 130%, 140%, 150%, 160%, 170%, 180% of the TSF of the same mullite body lacking such carbon or made in the same way, but in the absence of a carbon containing material. The TSF may even be double that of a mullite body lacking said carbon or made in the absence of the carbon containing material. Generally, the thermal shock factor is at least about 200° C., more preferably at least about 225° C., and most preferably at least about 250° C. The thermal shock factor (TSF) is given by the following equation:

$$TSF = \frac{Strength}{( Modulus ) ( CTE )}$$

where CTE is the coefficient of thermal expansion given in (1/° C.). As an illustration, mullite's average CTE is about 5×10⁻⁶ per ° C. (note, CTE varies somewhat with temperature, but typically the average CTE from room temperature to about 800° C. is used when employing the above equation).

The TSF increase, to a small extent, may be due to a decrease in CTE, for example, when made with silicon carbide as the carbon containing material, but surprisingly, the strength is substantially increased without an increase in modulus. This increased strength is useful, for example, when the body is used as an exhaust particulate trap to survive being placed in a metal can that connects to an exhaust system as well as the mechanical forces encountered in use. For example, the TSF of the body of this invention may have a strength that is 110%, 120%, 130%, 140%, 150%, 160%, 170%, 180% of the strength of the same body lacking such carbon or made in the same way, but in the absence of a carbon containing material.

Generally, the strength is at least about 15 MPa. Preferably, the strength is at least about 17 MPa, more preferably the retained strength is at least about 19 MPa, even more preferably at least about 20 MPa and most preferably at least about 25 MPa. The retained strength is generally determined by 4 point bending of a bar cut from a body such as a honeycomb useful for making a particulate filter. The strength measurement may be made using a known technique such as described by ASTM C1161.

### Forming the Body Comprised of Mullite

In making the body, precursor compounds containing Al, Si and oxygen (i.e., elements present in mullite) are mixed with a carbon containing material to form a mixture. Precursor compounds that may be used are described in U.S. Pat. Nos. 5,194,154; 5,198,007; 5,173,349; 4,911,902; 5,252,272; 4,948,766 and 4,910,172.

Generally, the mixture is comprised of clay (i.e., hydrated aluminum silicate) and precursor compounds such as, alumina, silica, aluminum trifluoride, fluorotopaz and zeolites. The precursor compounds may include clay, silica, alumina and mixtures thereof. Preferably, the mixture is comprised of clay and alumina or silica and alumina. The mixture may contain other compounds such as those described as property enhancing compounds as described by U.S. Pat. No. 7,485,594 at col. 5, lines 50-67.

The precursor compounds are selected in proportions so that the resultant body has an Al/Si bulk mullite stoichiometry as described previously. It is understood herein that the Al/Si stoichiometry refers to the aluminum and silicon in the precursor that actually form the mullite. That is to say, if the fluorine source, for example, is AlF₃, the amount of SiO₂ present in the precursors for stoichiometry purposes must be reduced by an amount of SiF₄ that is volatalized off by the reaction of the fluorine from the AlF₃ with the SiO₂ to form SiF₄.

The carbon containing material is (i) an organic compound containing carbon that decomposes to form graphitic, amorphous carbon or inorganic compound containing carbon upon heating of step (b); (ii) graphitic carbon; (iii) amorphous carbon; (iv) inorganic compound containing carbon or (v) combination thereof to form a mixture.

When the carbon containing material is the organic compound containing carbon it is understood said compound needs to form the graphitic carbon, amorphous carbon or inorganic compound containing carbon. The amount and environment used to create the carbon may be determined without under burden by an ordinary skilled artisan. Typically, to decompose such organic compounds to form the carbon containing material may be done by heating as described below. Such heating may be done in the same furnace as part of the heating cycle comprising heating under a fluorine gas further described below or may be done separately.

The temperature and time of the heating must be sufficient enough to decompose the organic compound and form the carbon containing compound, but not so great that the mixture reacts or otherwise deleteriously affects the formation of the body upon heating in a fluorine atmosphere. Generally, the heating temperature is at most about 800° C., but is preferably in ascending preference at most about 750°, 700, 650°, 600°, 550° C., and 500° C. The temperature, generally, is at least 300° C. or else the time to decompose and form the carbon containing ceramic may be longer than desired. Typically the temperature is at least in ascending order 350°, 400°, and 450° C. The time at temperature may be any suitable to form the carbon containing material. Typically the time may range from minutes to days, with practical time of several minutes to several hours being typical.

The organic compound, if it forms the carbon as described above, may also facilitate the shaping of the mixture into a shaped body (e.g., honeycomb). Examples of such organic compounds include, for example, binders and dispersants, such as those described in Introduction to the Principles of Ceramic Processing, J. Reed, Wiley Interscience, 1988. Other examples of such organic compounds include those described by U.S. Pat. No. 5,384,291 from col. 3, line 3 to col. 4, line 34.

Further examples of organic compounds are ones that can form metal carbides upon decomposition. These type of organic compounds are often referred to as preceramic polymers. Examples of these are described by U.S. Pat. Nos. 4,226,896; 4,310,482; 4,800,221; 4,832,895; 5,312,649; 6,395,840 and 6,770,583 and in Defense Technical Information Center publication, Preceramic Polymers: Past, Present and Future, Seyferth, Dietmar, Accession Number: ADA258327, Nov. 2, 1992 and Comprehensive Chemistry of Polycarbosilanes, Polysilazanes, and Polycarbosilazanes as Precursors of Ceramics, M. Birot et.al., Chem. Rev. 1995, 95, 1443-1477. The polymer may be, silicones or silicone oils when making silicon carbide compounds or silicon oxy-carbide compounds, such as described by Thermal Decomposition of Commercial Silicone Oil to Produce High Yield High Surface Area SiC Nanorods, V. G. Pol et.al., J. Phys. Chem. B 2006, 110, 11237-11240. A particular example, is the commercially available polymer STARFIRE SMP-10 available from Starfire Systems Inc., Malta, N.Y.

The atmosphere, typically, is one that is sufficiently devoid of oxygen such that the above organic compound, does not merely oxidize forming, for example, water, nitrous oxide, carbon monoxide, carbon dioxide or a metal oxide. Some oxygen, however, may be present such that an oxy-carbide is formed if desired. Typically, the atmosphere may be inert (e.g., noble gas) or autogenic (i.e., sealed and the creation of CO from the oxidation of the polymer is sufficient to form the carbon containing material).

The carbon containing material may be a graphitic carbon or amorphous carbon particulates such as those known in the art. Typically the particulate size and distribution are any suitable for making the mixture, but typically have an average particle size of at most about 20 micrometers.

Desirably, the average size is at most 15 micrometers, 10 micrometers, 5 micrometers, 3 micrometers, 1.5 micrometers or even 1 micrometer to at least about 10 nanometers by weight. Suitable graphitic carbon include those well known in the art and commercially available. Amorphous carbons include those that are known as carbon blacks, acetylene black, lamp black and the like and are available from companies such as Cabot Corporation, Boston Mass.

The carbon containing material may also be an inorganic compound containing carbon. The inorganic compound containing carbon may be, for example, a metal carbide, metal oxy-carbide, metal nitro-carbide or metal oxy-nitro-carbide. Examples of metals of such compounds may be any of those metals that create a carbide being refractory in nature. Examples, of such metals are Si, Al, W, Hf, Zr, Ti, V, B, and combination thereof. Particular examples include, silicon carbide, aluminum carbide, aluminum boron carbide, tungsten carbide, zirconium carbide, hafnium carbide and combinations thereof. It is understood that such carbides may have differing stoichiometries and such differing stoichiometries are contemplated herein.

The carbon containing material is added to the mixture in an amount so that the mixture has an amount of carbon to realize the desired bulk carbon in the body as described above. Typically this means there is about 0.1 percent to about 30 percent by weight of the mixture. It is understood that when the organic compound is used the amount of carbon that is lost upon decomposing to form the graphitic carbon, amorphous carbon or inorganic compound containing carbon is not included in the aforementioned range. Generally, the amount of the carbon is at least 0.2, 0.2, 0.3, 0.5, 0.75, 0.9, or 1 percent to at most 2, 3, 4, 5,6, 7, 8, 9, 10, 12, 15, or 20 percent by weight of the mixture.

The inorganic compound containing carbon desirably has the same particle size as described previously for graphitic carbon and amorphous carbon.

The mixture may be made by any suitable method such as those known in the art. Examples include media milling (e.g., ball or attrition milling), ribbon blending, vertical screw mixing, and V-blending. The mixture may be prepared dry (i.e., in the absence of a liquid medium) or wet. When the mixture is prepared wet, the liquid medium may be any useful solvent to make such mixtures such as water or organic solvents (e.g., alcohols, alkanes, esters, ethers or combinations thereof). Typically, water is used.

The mixture is then typically shaped into a porous shape by any suitable method, such as those known in the art. Examples include injection molding, extrusion, isostatic pressing, slip casting, roll compaction and tape casting. Each of these is described in more detail in Introduction to the Principles of Ceramic Processing, J. Reed, Chapters 20 and 21, Wiley Interscience, 1988.

The shaped porous shape is then heated under an atmosphere containing fluorine to a temperature sufficient to form the mullite composition. Fluorine may be provided in the gaseous atmosphere from sources such as SiF₄, AlF₃, HF Na₂SiF₆ NaF and NH₄F. Preferably, the source of fluorine is from SiF₄. Preferably the fluorine is separately provided. “Separately provided” means that the fluorine containing gas is supplied not from the compounds in the mixture (e.g., AlF₃), but from an external gas source pumped into the furnace heating the mixture. This gas preferably is a gas containing SiF₄.

Generally in the method, the porous body is heated to a first temperature for a time sufficient to convert the precursor compounds in the porous body to fluorotopaz in the presence of the fluorine containing gas and then raised to a second temperature sufficient to form the mullite composition where the fluorine gas is removed or purged from the atmosphere. The temperature may also be cycled between the first and second temperature to ensure complete mullite formation. The first temperature typically is from about 500° C. to about 950° C. Preferably, the first temperature is at least about 550° C., more preferably at least about 650° C. and most preferably at least about 725° C. to preferably at most about 850° C., more preferably at most about 800° C. and most preferably at most about 775° C.

The second temperature may be any temperature suitable depending on variables such as the partial pressure of SiF₄ in the atmosphere. Generally, the second temperature is at least about 960° C. to at most about 1700° C. Preferably, the second temperature is at least about 1050° C., more preferably at least about 1075° C. and most preferably at least about 1100° C. to preferably at most about 1600° C., more preferably at most about 1400° C. and most preferably at most about 1200° C.

Depending on the carbon containing material used in the mixture, during the heating to the first temperature, the atmosphere is, typically, inert (e.g., nitrogen) or a vacuum until at least about 500° C., which is when a separately provided fluorine containing gas is desirably introduced. During heating to the first temperature water or other liquid solvent may be removed and organic compounds decomposed to form the carbon containing material as described above. Other organic compounds may also be removed (e.g., evaporate and do not decompose such as low molecular weight surfactants and lubricants). The water removal and decomposition of the organic compounds may also be removed in a separate heating step as described above.

After cooling and forming a porous body comprised of mullite having fluorine, the mullite composition is further heat treated to form the final body comprised of mullite having the fluorine removed. The amount of fluorine in the bodies after this heat treatment is less than 1% by weight and generally is less than 0.8%, 0.6%, 0.3%, 0.1%, 0.01% or even no fluorine present by weight of the body. In the absence of such heat treatment, the fluorine is typically at least about 2% by weight. This heat treatment may be carried out in air, water vapor, oxygen, an inert gas or mixture thereof for a time sufficient to form the further porous body of this invention. Examples of inert gases include nitrogen and the noble gases (i.e., He, Ar, Ne, Kr, Xe, and Rn). Preferably, the heat treatment atmosphere is an inert gas, air, water vapor or mixture thereof. More preferably, the heat treatment atmosphere is nitrogen, air or air containing water vapor.

The time at the heat treatment temperature is a function of the heat treatment atmosphere, particular mullite composition and temperature selected. For example, a heat treatment in wet air (air saturated with water vapor at about 40° C.) generally requires more than several hours to 48 hours at 1000° C. In contrast, ambient air, dry air or nitrogen (air having a relative humidity from about 20 percent to 80 percent at room temperature) desirably is heated to 1400° C. for at least about 2 hours.

Generally, the time at the heat treatment temperature is at least about 0.5 hour and is dependent on the temperature used (i.e., generally, the higher the temperature, the shorter the time may be). Preferably, the time at the heat treatment temperature is at least about 1 hour, more preferably at least about 2 hours, even more preferably at least about 4 hours and most preferably at least about 8 hours to preferably at most about 4 days, more preferably at most about 3 days, even more preferably at most about 2.5 days and most preferably at most about 2 days.

The porous body may be particularly useful as a support for a catalyst, such as precious metal catalyst on alumina particles, typically referred to as a catalyst wash coat, used in automotive catalytic converters. It is also preferred that the wash coat makes a thin coating on at least a portion of the grains making up the porous body. A portion is generally when at least about 10 percent of the area of the grains of one region are covered by the catalyst coating. Preferably, substantially all of the grains of one region are coated. More preferably, substantially all of the grains of the composition are coated. Other catalyst applications the porous body may be useful for, include, for example, a catalytic combustor.

Thin coating means that the catalyst wash coating has a thickness generally less than the average smallest dimension of the grains coated. Generally, the thickness of the coating is at most about half the thickness, preferably at most about one third and most preferably at most about one quarter the thickness of the average smallest dimension of the grains coated.

The porous body may also be particularly useful as a particulate (soot) trap and oxidation (i.e., exhaust) catalyst for mobile power applications (e.g., diesel engines) and stationary power applications (e.g., power plants). The porous body, when used as a diesel particulate trap, may have at least a portion of the grains coated with a catalyst, as described above. Of course, the porous body may be useful as soot trap itself without any catalyst.

### EXAMPLES

### Comparative Example 1a and 1b

An extrusion paste was made consisting of 63.7 wt % of mullite precursor powder, 4.5 wt % of methyl cellulose (METHOCEL A4M, available from The Dow Chemical Co. Midland, Mich.), and 31.8 wt % of water. The mullite precursor powder was a mixture of the following: 25.35 wt % ball milled clay (EUBC01 Hywite Alum, available from Ceramiques Techniques & Industrielles S. A., Salindres, France, “CTI”), 46.40 wt % alumina powder (CTIKA01, available from CTI), and 25.35 wt % kaolin powder (EUBC03 Argical-C 88R, available from CTI), 0.30 wt % iron oxide (Fe-601, available from Atlantic Equipment Engineers, Bergenfield, N.J.), 2.60 wt % raw talc (WC&D raw talc MB50-60, available from Applied Ceramics, Atlanta, Ga.). The chemical composition of mullite precursor was 69.7 wt % of Al₂O₃, 27.3 wt % of SiO₂, 1.0 wt % MgO, 1.0 wt % of Fe₂O₃, 0.6 wt % of TiO2, 0.3 wt % of K₂O, and 0.1 wt % of CaO.

The extrusion paste was extruded using a lab extruder from HANDLE GMBH (Germany)into bars having dimension of 12.7 mm×2.5 mm×75 mm. The bars were heated in air at a ramp rate of 1.25° C. per minute to 1050° C. and held at that temperature for 2 hours to remove the carbonaceous organic additives to form calcined bars.

The calcined bars were then heated to 700° C. at ramp rate of 1° C./min under 3 torr vacuum. Upon the bars equilibrating at 700° C., flowing silicon tetrafluoride gas was introduced to form fluorotopaz. Absorption of SiF₄ was complete based on the initial drop in reactor pressure then leveling out to a constant pressure over time. The un-absorbed gas was removed from the reactor. The reaction pressure during removal was reduced to 38 torr. The reactor was then backfilled with 100% SiF₄ to a partial pressure of 150 torr. Upon backfilling, the reactor contents were initially heated at 2° C./min to 980° C., then reduced to 1° C./min from 980 to 1150° C. The flow of silicon tetrafluoride was then ceased and the gas remaining in the reactor was then removed. The reactor was subsequently purged with nitrogen while it was cooled to room temperature.

These as formed acicular mullite bars are referred to “as formed” acicular mullite bars (Comp. Ex. 1a). They have a fluorine content of about 2% by weight. The acicular mullite bars after being cooled and removed from the furnace were subsequently heated in air to a temperature of 1400° C. for 6 hours (final mullite bars—Comp. Ex. 1b). The amount of fluorine of these final bars was less than 1% by weight of the body.

The Young's modulus of the final mullite bars were determined using the method outlined in ASTM C 1259-94, “Standard Test Method for Dynamic Young's Modulus, Shear Modulus, and Poisson's Ratio for Advanced Ceramics by Impulse Excitation of Vibration” using an GrindoSonic impulse excitation instrument c instrument (MK5 Industrial from J. W. Lemmens, Inc, Bridgeton, Mo.). The strength of the bars was determined using a 4-point bend test on an INSTRON 5543 Load Frame (Illinois Tool Works, Norwood, Mass.) following ASTM Standard C1161. A thermomechanical analyzer (TMA) was used to measure coefficient of thermal expansion (CTE) of honeycomb samples. The instrument used was TMA 2940 from TA Instruments. Honeycomb samples of about 10 mm in height were prepared for CTE measurement. In CTE measurement, samples were under a 0.05 N load and heated from room temperature to 800° C. at 5° C./min ramp rate under nitrogen. CTE was calculated by the degree of expansion divided by the change in temperature from room temperature to 800° C. Mercury porosimetry analysis was performed on a Micromeritics Autopore IV 9520 (Micromeritics Instrument Corporation, Norcross, Ga.). The samples were dried at 120° C. for 2 hours and then mechanically out-gassed while under vacuum prior to analysis to remove any physiosorbed species (i.e., moisture) from the sample's surface. Approximately 0.8 gram of each sample was used for the analysis. The porosity and pore size of the mullite of this Comparative Example was determined by mercury porosimetry. The bulk carbon of the final bars was determined using combustion analysis employing a LECO CS844 Analyzer using Combustion Infrared Detection Technique. The Young's modulus, bend strength, and CTE, bulk carbon, porosity and pore size of this Comparative Example 1a and 1b are shown in Table 1.

### Examples 1a and 1b

The mullite bars of this Example were made in the same manner as in Comparative Example 1a, except that the mullite precursor powder used to make the extrusion paste consisted of 95% by weight of the mullite precursor powder of Comparative Example A and 5% by weight of silicon carbide powder were pre-mixed. The extrusion paste consisted of 64.3wt % of mullite precursor powder (i.e., 61.1 wt % of mullite precursor powder of Comparative Example 1a plus 3.2 wt % of silicon carbide powder), 4.5 wt % of methyl cellulose (METHOCEL A4M, available from The Dow Chemical Co. Midland, Mich.), 31.2 wt % of water. The silicon carbide powder used was HSC490N available from Superior Graphite Co., Chicago, Ill. having an average particle size of 0.6 micrometers.

The properties of the bars of this Example not treated (as formed) and further heat treated (Example 1a and 1b respectively) are shown in Table 1. The not treated bars had a fluorine content of about 2% by weight of the body. The heat treated bars had a fluorine content less than 1% by weight of the body. It is understood that the not treated (as formed) of this Example are not examples of the body, but are an illustration of a part of the method of this invention.

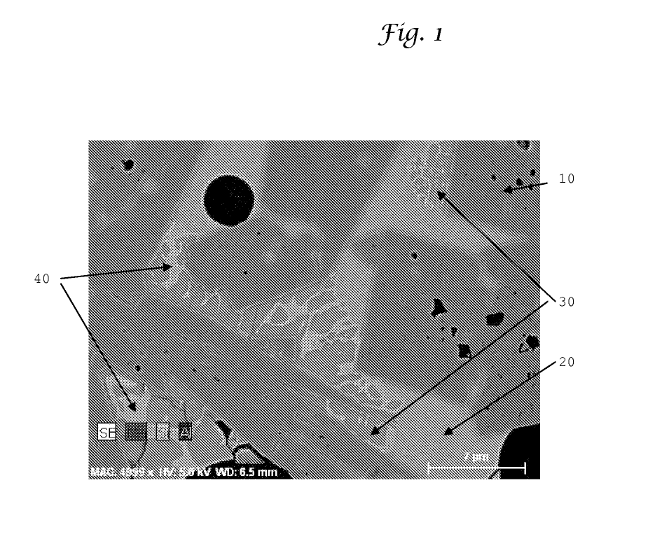

FIG. 1 shows a scanning electron micrograph of a polished section of Example 1b where the mullite grains (10) are bound together by a silicate glass (20), crystalline silica (30) domains in the silicate glass (20) which has magnesium rich silicate glass (40) regions. In this particular Figure, SiC particulates are not shown.

### Example 2

The mullite bars of this Example were made in the same manner as described in Examples 1a and 1b, except that the mullite precursor powder used to make the extrusion paste consisted of 90% by weight of the mullite precursor powder of Comparative Example A and 10% by weight of silicon carbide powder were pre-mixed. The extrusion paste consisted 64.6 wt % of mullite precursor powder (58.1 wt % of mullite precursor powder of Comp. Ex. 1a, 6.5 wt % of silicon carbide powder), 4.5 wt % of methyl cellulose (METHOCEL A4M, available from The Dow Chemical Co. Midland, Mich.), and 31.0 wt % of water.

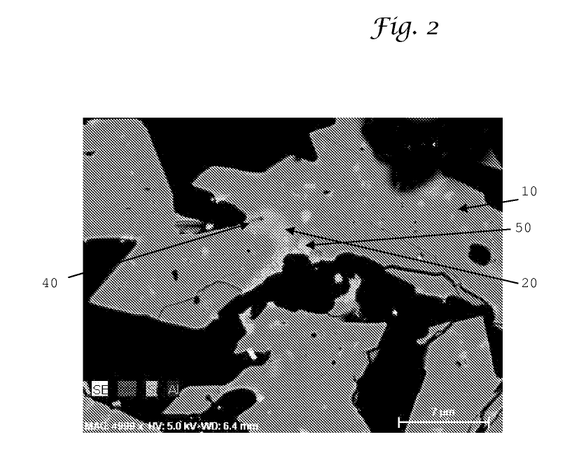

The properties of the heat treated bars of this Example are shown in Table 1. FIG. 2, which is an energy dispersive X-ray spectroscopy micrograph of this Example, shows mullite grains (10) bound together with a grain boundary phase of silicate glass (20) having magnesium rich glass (40) and silicon carbide (50).

### Example 3

The mullite bars of this Example were made in the same manner as described in Examples 1a and 1b, except that the mullite precursor powder used to make the extrusion paste consisted of 85% by weight of the mullite precursor powder of Comparative Example 1a and 15% by weight of silicon carbide powder were pre-mixed. The extrusion paste consisted 64.5 wt % of mullite precursor powder (54.8 wt % of mullite precursor powder of Comp. Ex. 1a, 9.7 wt % of silicon carbide powder), 4.5 wt % of methyl cellulose (METHOCEL A4M, available from The Dow Chemical Co. Midland, Mich.), and 31.0 wt % of water.

The properties of the further heat treated bars of this Example are shown in Table 1.

### Example 4

The mullite bars of this Example were made in the same manner as described in Examples 1a and 1b, except that the silicon carbide powder, F1000 silicon carbide powder having an average particle size of 4.5 micrometers available from Panadyne, Warwick, Pa. was used. The properties of the bars of this Example after further heat treatment are shown in Table 1.

### Example 5

The mullite bars of this Example were made in the same manner as described in Examples 1a and 1b, except that the silicon carbide powder, F360 silicon carbide powder having an average particle size of 23 micrometers available from Panadyne, Warwick, Pa. was used. The properties of the further heat treated bars of this Example are shown in Table 1.

### Example 6

The mullite bars of this Example were made in the same manner as described in Examples 1a and 1b, but instead of using silicon carbide powder, boron carbide powder HSCB4C available from Superior Graphite Co., Chicago, Ill. having an average particle size of 0.6 micron was used. The properties of the bars of this Example after further heat treatment are shown in Table 1.

### Example 7

The mullite bars of this Example were made in the same way as Comparative Examples 1a and 1b, except that the bars were not subject to the heating to 1050° C. temperature to remove the carbonaceous organic material so as to form calcined bars. The extruded bars were merely dried in air and then directly mullitized and further heat treated as described in Comparative Example 1a and 1b. The properties of the bars of this Example after further heat treatment are shown in Table 1.

From Table 1, the Examples show that when a sufficient amount of carbon is present when forming porous bodies comprised of mullite by heating in a fluorine containing gas and subsequently removing the fluorine, the properties of the body are improved. In particular, when silicon carbide is used particularly improved properties are shown when the amount of SiC in the mixture is from about 5 to 10% of the starting mixture, which results in carbon in the body of about 0.018 percent by weight. It also appears that smaller silicon carbide is beneficial, which is not understood, but may be, without limiting the invention that it is incorporated into the glass more easily or more uniformly than larger sizes as shown by Example 2.

TABLE 1

| | | Carbon | Carbon source | | | | | Thermal | | Average | | |
|---|---|---|---|---|---|---|---|---|---|---|---|---|
| | | Source | added % by | Heat | | | Thermal | Shock | | Pore | Bulk | |
| | Added | Particle | weight of | Treated | Elastic | MOR | Expansion | Factor | Por- | Size | Carbon | TSF |
| | Carbon | Size Avg. | Mullite | at | Modulus | Strength | Coefficient | (TSF) | osity | (mi- | content | Change* |
| Example | Source | (micron) | Precursor | 1400° C. | (GPa) | (MPa) | (ppm/° C.) | (° C.) | (%) | crons) | (wt %) | (%) |
| Comparative | NA | NA | 0% | no | 20.9 | 20.9 | 5.7 | 175 | Not | Not | 0.022 | Not |
| Example 1a | | | | | | | | | mea- | mea- | | appli- |
| | | | | | | | | | sured | sured | | cable |
| Comparative | NA | NA | 0% | yes | 21.3 | 22.4 | 5.7 | 184 | 61.8 | 8.7 | 0.003 | 100% |
| Example 1b | | | | | | | | | | | | |
| Example 1a | SiC | 0.6 | 5% | no | 16.7 | 19.1 | 5.7 | 201 | Not | Not | 1.373 | NA |
| | | | | | | | | | mea- | mea- | | |
| | | | | | | | | | sured | sured | | |
| Example 1b | SiC | 0.6 | 5% | yes | 17.5 | 26.7 | 5.7 | 268 | 58.1 | 7.7 | 0.016 | 145% |
| Example 2 | SiC | 0.6 | 10% | yes | 18.8 | 28.9 | 5.5 | 279 | 57.9 | 9.0 | 0.018 | 151% |
| Example 3 | SiC | 0.6 | 15% | yes | 16.8 | 21.2 | 5.9 | 214 | 56.8 | 9.1 | 0.018 | 116% |
| Example 4 | SiC | 4.5 | 5% | yes | 19.2 | 24.3 | 5.6 | 226 | 60.7 | 8.4 | 0.009 | 122% |
| Example 5 | SiC | 23 | 5% | yes | 18.9 | 24.3 | 5.6 | 230 | 60.9 | 10.5 | 0.006 | 124% |
| Example 6 | B4C | 0.6 | 5% | yes | 23.9 | 28.4 | 5.7 | 208 | NA | NA | 0.030 | 113% |
| Example 7 | Organic | Not | 1-3% | yes | 20.6 | 26.9 | 5.7 | 229 | Not | Not | 0.012 | 124% |
| | C | applicable | (estimated) | | | | | | mea- | mea- | | |
| | | | | | | | | | sured | sured | | |

*Comp. 1b is 100%. % change is TSF of Ex./TSF Comp. 1b multiplied by 100

1. A method for making a body comprised of mullite comprising,
(a) mixing one or more precursor compounds having the elements present in mullite and a carbon containing material that is: (i) an organic compound containing carbon that decomposes to form graphitic, amorphous carbon or inorganic compound containing carbon upon heating of step (b); (ii) graphitic carbon; (iii) amorphous carbon; (iv) inorganic compound containing carbon or (v) combination thereof to form a mixture,
(b) heating the mixture of step (b) under an atmosphere having a fluorine containing gas to form a porous body comprised of mullite and having fluorine in an amount greater than 1% by weight, and
(c) removing the fluorine to form the porous body comprised of mullite, wherein the amount of fluorine is less than 1% by weight of the body.

2. The method of claim 1 further comprising heating the mixture prior to the heating of step (b) under an atmosphere that is a reducing atmosphere, inert, or vacuum such that the organic compound decomposes and forms graphitic carbon, amorphous carbon, inorganic compound containing carbon or combination thereof.

3. The method of claim 2 wherein the precursor compounds are clay, alumina, silica, fluorotopaz, zeolite, aluminum trifluoride or mixtures thereof.

4. The method of claim 1 wherein the carbon containing material is graphitic carbon, amorphous carbon, metal carbide or combination thereof.

5. The method of claim 4 wherein the carbon containing material is the metal carbide.

6. The method of claim 5, wherein the metal carbide is silicon carbide, boron carbide, aluminum carbide, aluminum boron carbide, tungsten carbide, titanium carbide, vanadium carbide or combinations thereof.

7. The method of claim 6, wherein the metal carbide is silicon carbide.

8. The method of claim 6 wherein the amount of carbon material in the mixture is sufficient such that the porous body comprised of mullite has a bulk carbon content of 0.005% to 10% by weight of said body.

9. The method of claim 5, wherein the metal carbide has an average particle size of at most 3 micrometers.

10. The method of claim 8, wherein the average particle size is at most 1.5 micrometers.

11. The method of claim 1, wherein the mixture has an Al/Si ratio of greater than 3 to 4.5.

12. The method of claim 11, wherein the Al/Si ratio is from 3.8 to 4.2.

13. The method of claim 1, wherein the mixture has a metal impurity concentration of at most 0.5% by weight of the mixture.

14. The method of claim 1, wherein the mullite is comprised of grains that are acicular.

15. The method of claim 14, wherein the removing is accomplished by heating in an oxygen containing atmosphere such that the amount of fluorine is reduced to less than 0.3% by weight.

16. A porous body comprised of acicular mullite grains bound together by a ceramic grain boundary phase, wherein the bulk carbon content is from 0.005% to 10% by weight of the porous body and the amount of fluorine is less than 1%.

17. The porous body of claim 16, wherein the ceramic grain boundary phase has dispersed therein a metal carbide.

18. The porous body of claim 17, wherein the metal carbide is silicon carbide.

19. The porous body of claim 15 wherein the ceramic grain boundary phase is an aluminosilicate glass having therein a crystalline silica phase.

20. A particulate filter comprised of the porous body of claim 16.
